(19) United States
(12) Patent Application Publication
(10) Pub. No.: US 2025/0214414 A1
(43) Pub. Date: Jul. 3, 2025

(54) ACTIVE AIR INTAKE ASSEMBLY AND MOTOR VEHICLE

(71) Applicant: GUANGZHOU VALEO ENGINE COOLING Co., Ltd, Guangzhou (CN)

(72) Inventors: Praveen Babu, Chennai (IN); Vengatesh Loganathan, Chennai (IN); Ranjith-Kumar Kalidass, Chennai (IN); Arunkumar Subramanian, Chennai (IN); Sebastien Velasco, Chennai (IN)

(73) Assignee: GUANGZHOU VALEO ENGINE COOLING Co., Ltd, Guangzhou (CN)

(21) Appl. No.: 19/005,282

(22) Filed: Dec. 30, 2024

(30) Foreign Application Priority Data
Dec. 29, 2023 (CN) 202323664195.3

(51) Int. Cl. B60K 11/08

(52) U.S. Cl. CPC B60K 11/085

(57) ABSTRACT

An active air intake assembly includes a frame, and first and second vanes. The frame extends in a longitudinal direction and is provided with an opening for air intake. The first and second vanes extend in the longitudinal direction and are rotatably fixed to the frame by a common axis of rotation, and are able to move away from each other from a closed position to an open position to open the opening. The active air intake assembly has an enhanced air intake regulation capability. A motor vehicle that includes the active air intake assembly is also disclosed herein.

### TECHNICAL FIELD

The present invention relates to the field of vehicle equipment, specifically to an active air intake assembly and a motor vehicle with such an active air intake assembly.

### BACKGROUND ART

Many motor vehicles have mechanisms for air intake, such as air intake grilles, on the front face. Air from the front of the vehicle enters the interior of the vehicle via the air intake grille, for example for the operation of an internal combustion engine or for temperature regulation of various components within the vehicle.

The air intake grille of some motor vehicles is known as an active air intake grille. Vanes that are mounted on the active air intake grille can be actively controlled by the vehicle, so that the positions of the vanes are adjusted according to various requirements, thereby regulating the flow of air through the air intake grille. In another aspect, in general, the appearance of the air intake grille as seen from the outside of the vehicle has an aesthetic effect on the appearance of the front face of the vehicle, as the air intake grille is located on the front face of the vehicle.

Therefore, there is still a desire to have an air intake assembly that has an enhanced air intake regulation capability and can help the vehicle to have a specific front face appearance.

### SUMMARY OF THE INVENTION

Regarding the above problem, according to a first aspect of the present invention, an active air intake assembly is proposed, comprising: a frame that extends in a longitudinal direction and is provided with an opening for air intake; first and second vanes that extend in the longitudinal direction, the first and the second vanes respectively being rotatably fixed to the frame by a common axis of rotation, and being able to move away from each other from a closed position to an open position to open the opening.

In the active air intake assembly according to the present invention, a simple mechanism enables the first vane and the second vane to move away from each other to an open position, and air flowing through the opening of the active air intake assembly is not obstructed by the vanes at the overall middle of the opening, thereby significantly increasing an amount of air that can flow through the opening at a lower cost, so as to enhance the air intake regulation capability; at the same time, by having the first and second vanes open the opening by dividing into halves, the active air intake assembly has a specific appearance different from that of existing air intake grilles.

The active air intake assembly according to the present invention may have one or more of the following features.

According to one embodiment, preferably, the first vane is fixedly provided with a first rotating arm, one end of the first rotating arm is fixedly mounted to a main body of the first vane, and a part of the first rotating arm that is different from said end is rotatably mounted to a rotary shaft on the frame; the second vane is fixedly provided with a second rotating arm, one end of the second rotating arm is fixedly mounted to a main body of the second vane, and a part of the second rotating arm that is different from said end is rotatably mounted to the rotary shaft on the frame; and the first rotating arm and the second rotating arm form a scissor structure, such that, at the closed position, an included angle between the first rotating arm and the second rotating arm is a first included angle, and, at the open position, the included angle between the first rotating arm and the second rotating arm is a second included angle, and the second included angle is greater than the first included angle.

According to one embodiment, preferably, the opening is defined by a first side edge and a second side edge that are opposite each other and extend in the longitudinal direction; and the common axis of rotation extends in the longitudinal direction, and the common axis of rotation is located between the first side edge and the second side edge.

According to one embodiment, preferably, the active air intake assembly further comprises a drive apparatus, the drive apparatus being configured to drive the first vane and the second vane, such that the included angle varies between the first included angle and the second included angle.

According to one embodiment, preferably, the drive apparatus comprises a crank connecting rod mechanism, a first drive arm and a second drive arm, wherein the crank connecting rod mechanism comprises a prime mover, the first drive arm is rotatably connected to the first rotating arm, the second drive arm is rotatably connected to the second rotating arm, and the first drive arm and the second drive arm are rotatably connected to each other by means of a common pivot, and the common pivot is rotatably connected to the prime mover and slides relative to the prime mover.

According to one embodiment, preferably, the first rotating arm has a first end and a second end that are located on two sides of the corresponding rotary shaft, and the first end of the first rotating arm is closer to the first vane compared to the second end of the first rotating arm, and the second rotating arm has a first end and a second end that are located on two sides of the corresponding rotary shaft, and the first end of the second rotating arm is closer to the second vane compared to the second end of the second rotating arm.

According to one embodiment, preferably, the first drive arm is rotatably connected to the second end of the first rotating arm, and the second drive arm is rotatably connected to the second end of the second rotating arm.

According to one embodiment, preferably, the first vane comprises two or more first vane sections that are arranged in the longitudinal direction, and the second vane comprises two or more second vane sections that are arranged in the longitudinal direction.

According to one embodiment, preferably, the first rotating arm is arranged at an end part of the first vane section, and the second rotating arm is arranged at an end part of the second vane section.

According to one embodiment, preferably the drive apparatus is arranged in the longitudinal direction between the vane sections or at end parts of the vanes.

According to one embodiment, preferably the first vane, the second vane and the opening all have a curved surface shape protruding at a middle part in the longitudinal direction away from an air intake channel, so that an olive-shaped opening can be formed between the first vane and the second vane. The active air intake assembly according to this embodiment can have a further altered specific appearance.

According to a second aspect of the present invention, a motor vehicle is proposed, comprising the active air intake assembly according to any one of the embodiments described above.

### BRIEF DESCRIPTION OF THE DRAWINGS

In order to explain the technical solutions in embodiments of the present invention more clearly, the drawings accompanying embodiments of the present invention are briefly described below. The drawings are merely used to illustrate some embodiments of the present invention, without limiting all embodiments of the present invention to this.

FIG. 1A is an outer perspective view of a first embodiment of an active air intake assembly according to the present invention, in which first and second vanes are closed.

FIG. 1B is an outer perspective view of the first embodiment of the active air intake assembly according to the present invention, in which the first and second vanes are open.

FIG. 2A is an inner perspective view of the first embodiment of the active air intake assembly according to the present invention, in which the first and second vanes are closed.

FIG. 2B is an inner perspective view of the first embodiment of the active air intake assembly according to the present invention, in which the first and second vanes are open.

FIG. 3A is an outer exploded perspective view of the first embodiment of the active air intake assembly according to the present invention.

FIG. 3B is an inner exploded perspective view of the first embodiment of the active air intake assembly according to the present invention, wherein a drive apparatus is not shown.

FIG. 3C is a partial exploded perspective view of a drive apparatus of the first embodiment of the active air intake assembly according to the present invention.

FIG. 4A is a sectional side view of the first embodiment of the active air intake assembly according to the present invention, in which the first and second vanes are closed.

FIG. 4B is a sectional side view of the first embodiment of the active air intake assembly according to the present invention, in which the first and second vanes are open.

FIG. 5A is an outer perspective view of a second embodiment of an active air intake assembly according to the present invention, in which first and second vanes are closed.

FIG. 5B is an outer perspective view of the second embodiment of the active air intake assembly according to the present invention, in which the first and second vanes are open.

FIG. 6A is an inner perspective view of the second embodiment of the active air intake assembly according to the present invention, in which the first and second vanes are closed.

FIG. 6B is an inner perspective view of the second embodiment of the active air intake assembly according to the present invention, in which the first and second vanes are open.

FIG. 7 is an inner partial view of the second embodiment of the active air intake assembly according to the present invention, in which the first and second vanes are open.

FIG. 8A is a sectional side view of the second embodiment of the active air intake assembly according to the present invention, in which the first and second vanes are closed.

FIG. 8B is a sectional side view of the second embodiment of the active air intake assembly according to the present invention, in which the first and second vanes are open.

### LIST OF REFERENCE NUMERALS

1 active air intake assembly
100 frame
105 outer frame part
110 vertical plate
115 vertical beam
120 opening
121 first side edge
122 second side edge
150 rotary shaft
210 first vane
212 first rotating arm
2121 first end of first rotating arm
2122 second end of first rotating arm
215 first vane section
216 first connecting rod
220 second vane
222 second rotating arm
2221 first end of second rotating arm
2222 second end of second rotating arm
225 second vane section
226 second connecting rod
250 common axis of rotation
400 drive apparatus
410 first drive arm
420 second drive arm
430 prime mover
441 limiting rail
442 common pivot
450 crank connecting rod mechanism
460 electric motor
A1 first included angle
A2 second included angle
L longitudinal direction

### DETAILED DESCRIPTION OF THE INVENTION

In order to make clearer the objectives, technical solutions and advantages of the present invention, technical solutions provided by embodiments of the present invention will be clearly and completely described below with reference to the drawings of specific embodiments of the present invention. In the drawings, identical reference numerals denote identical elements. It should be noted that the described embodiments are some, but not all, embodiments of the present application. Any embodiments obtained by those of ordinary skill in the art on the basis of the described embodiments of the present invention without making inventive efforts fall under the scope of protection of the present invention.

Unless defined otherwise, the technical or scientific terms used herein shall have the common meanings as understood by those of ordinary skill in the art to which the present invention belongs. Words such as “first” and “second” used in the description and claims of the patent of the present invention do not denote any order, quantity or importance, and are merely used to distinguish different component parts. In the description of the present invention, it should be understood that orientational or positional relationships indicated by the terms “up”, “down”, “left”, “right”, “top”, “bottom”, etc. are based on the orientational or positional relationships shown in the drawings, and are merely intended to facilitate and simplify the description of the present invention, rather than indicating or implying that the apparatus or element referred to must have a specific orientation or be constructed and operated in a specific orientation, and therefore should not be construed as limiting the present invention.

The present invention is described in detail below by describing exemplary embodiments.

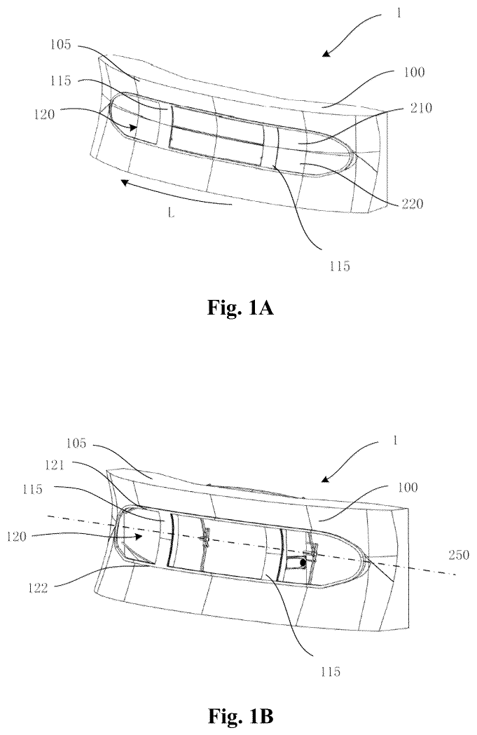

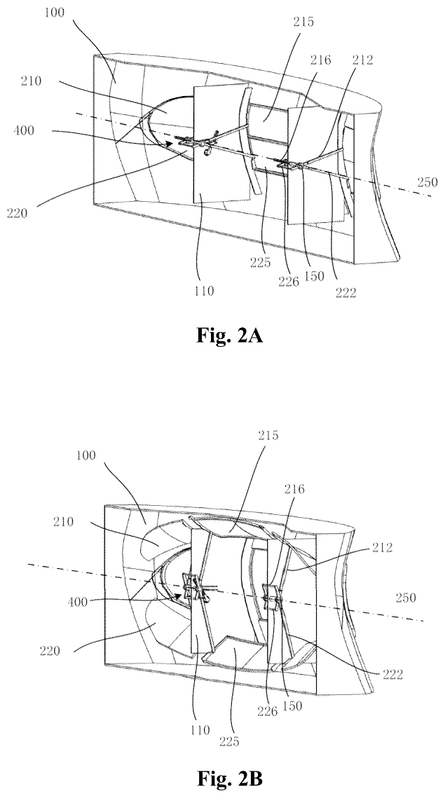

FIGS. 1A and 1B respectively show outer perspective views of an active air intake assembly 1 according to a first embodiment of the present invention. FIGS. 2A and 2B respectively show inner perspective views of the active air intake assembly 1 according to the first embodiment of the present invention. Herein, “outer perspective view” refers to a view of the active air intake assembly 1 as seen from the outside of a vehicle that is fitted with the active air intake assembly 1, and “inner perspective view” refers to a view of the active air intake assembly 1 as seen from the inside of a vehicle fitted with the active air intake assembly 1.

As shown in FIGS. 1A and 1B, the active air intake assembly 1 comprises a frame 100, a first vane 210 and a second vane 220. The frame 100 extends in a longitudinal direction L and has an opening 120 for air intake. Typically, the longitudinal direction L follows a horizontal direction of a motor vehicle that is fitted with the active air intake assembly 1. However, additionally, the orientational or positional relationships “up” or “down” described below are based only on the orientational or positional relationships of the components shown in the drawings.

The opening 120 is surrounded by an outer frame part 105 of the frame 100, as shown in FIGS. 1A and 1B. Thus, the opening 120 is defined by a first side edge 121 and a second side edge 122 that are opposite each other and extend in the longitudinal direction L. The frame 100 is provided at the opening 120 with two vertical beams 115 that are separated from end parts of the frame 100 in the longitudinal direction L, and are separated from each other in the longitudinal direction L, with each vertical beam 115 extending from the first side edge 121 to the second side edge 122. Thus, in this first embodiment, the vertical beams 115 divide the opening 120 into three opening sections arranged in the longitudinal direction L.

The inner viewing angles of FIGS. 2A and 2B further show the positional relationships of the frame 100, the first vane 210 and the second vane 220. As shown in FIGS. 2A and 2B, the first vane 210 is arranged at the upper side of the opening 120, the second vane 220 is arranged at the lower side of the opening 120, and the first vane 210 and the second vane 220 move away from each other from a closed position to an open position to open the opening 120. Thus, when the first vane 210 and the second vane 220 are in the closed position (FIGS. 1A and 2A), the opening 120 is closed and air cannot pass through the opening 120, and, when the first vane 210 and the second vane 220 are in the open position (FIGS. 1B and 2B), the opening 120 is opened and air can pass through the opening 120, without obstruction at least at a middle part of the opening 120, which increases the air intake capability of the active air intake assembly 1.

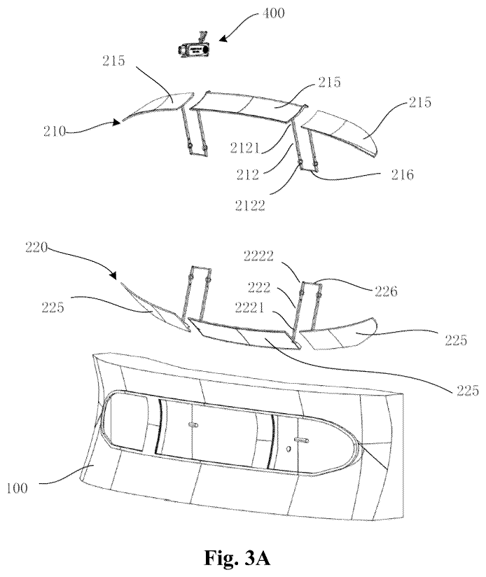

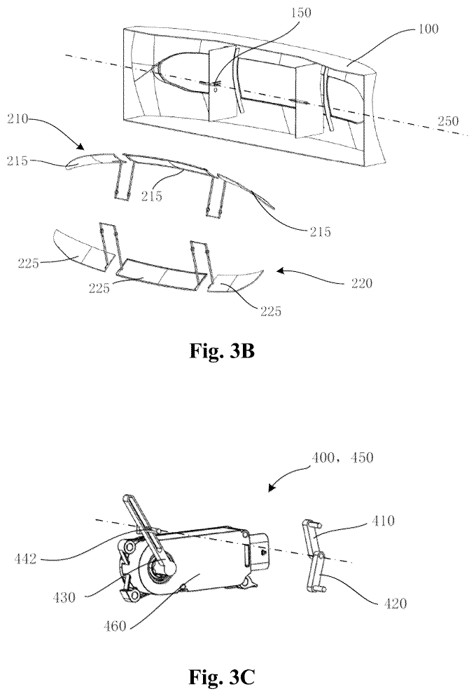

Next, the specific constructions of the components of the active air intake assembly 1 are described with reference to the respective exploded views of FIGS. 3A-3C.

As shown in FIGS. 3A and 3B, the first vane 210 comprises three first vane sections 215 arranged in the longitudinal direction L, and each adjacent pair of these three first vane sections 215 are configured to be fixedly connected to each other by means of a first connecting rod 216. Specifically, first rotating arms 212 are respectively fixed at two adjacent end parts of an adjacent pair of the first vane sections 215, that is, the first rotating arms 212 are fixedly mounted to main bodies of the first vane sections 215, and the first connecting rod 216 fixedly connects the first rotating arms 212 corresponding to the pair of adjacent first vane sections 215. This allows the entire first vane 210 to be moved by driving only one first vane section 215 of any of the three first vane sections 215.

As shown in FIGS. 3A and 3B, the second vane 220 comprises three second vane sections 225 arranged in the longitudinal direction L, and each adjacent pair of these three second vane sections 225 are configured to be fixedly connected to each other by means of a second connecting rod 226. Specifically, second rotating arms 222 are respectively fixed at two adjacent end parts of an adjacent pair of the second vane sections 225, that is, the second rotating arms 222 are fixedly mounted to main bodies of the second vane sections 225, and the second connecting rod 216 fixedly connects the second rotating arms 222 corresponding to the pair of adjacent second vane sections 225. This allows the entire second vane 220 to be moved by driving only one second vane section 225 of any of the three second vane sections 225.

In addition, as shown in FIGS. 3A and 3B, the first vane 210, the second vane 220 and the opening 120 each overall have a curved surface shape protruding at a middle part in the longitudinal direction L away from the active air intake assembly 1 (that is, away from an air intake channel). As a result, an olive-shaped opening can be formed between the first vane 210 and the second vane 220 in the opening process, giving the active air intake assembly 1 a more distinctive appearance.

In addition, as shown more clearly in FIG. 3B, the frame 100 comprises an outer frame part 105 thereof, vertical beams 115, and vertical plates 110 arranged on inner sides of the vertical beams 115. The vertical plates 110 are configured for mounting the first vane 210 and the second vane 220 mentioned above, and the drive apparatus 400 described below. FIG. 3B shows rotary shafts 150 for mounting the first vane 210 and the second vane 220 and arranged on the vertical plates 110.

FIG. 3A shows a schematic diagram of the drive apparatus 400, FIG. 3C shows a partial exploded perspective view of the drive apparatus 400, and FIGS. 3A and 3C show an electric motor 460 that cooperates with the drive apparatus 400. Specifically, the drive apparatus 400 comprises a crank connecting rod mechanism 450, a first drive arm 410 and a second drive arm 420, wherein the crank connecting rod mechanism 450 comprises a prime mover 430. The prime mover 430 is a lever shape, and an end part thereof is fixed to an output rotating shaft of the electric motor 460, so that the prime mover 430 can rotate with this end part as the centre of rotation, thereby outputting drive. A section of the prime mover 430 that is remote from this end part is provided with a slide rail along the length thereof, and the common pivot 442 is rotatably and slidably accommodated on this slide rail, so as to be rotatably connected to the prime mover 430 and able to slide relative to the prime mover 430. In addition, respective ends of the first drive arm 410 and the second drive arm 420 are rotatably connected through this common pivot 442, allowing the rotation of the prime mover 430 to drive the movement of the first drive arm 410 and the second drive arm 420.

Returning to FIGS. 2A and 2B, these show the first vane 210, the second vane 220 and the drive apparatus 400 mounted to the frame 100. Specifically, the first vane 210 is rotatably mounted to the corresponding rotary shaft 150 on the frame 100 via the first rotating arm 212 located at the end part of the first vane section 215, and the second vane 220 is rotatably mounted to the corresponding rotary shaft 150 on the frame 100 via the second rotating arm 222 located at the end part of the second vane section 225. For example, the first vane 210 and the second vane 220 approach the opening 120 of the frame 110 in sequence from the inner side, such that adjacent first rotating arms 212 of the first vane 210 partially go round the vertical plate 110, and adjacent second rotating arms 222 of the second vane 220 partially go round the vertical plate 110, and the first connecting rod 216 and the second connecting rod 226 remain on the inner side of the vertical plate 110. Next, the rotary shaft 150 passes through the first rotating arm 212 and the second rotating arm 222, which are located on two sides of the vertical plate 110, and said vertical plate 110. Thus, the first rotating arm 212 and the second rotating arm 222 are rotatably mounted to the rotary shaft 150 with a part that is different to the end by which each is mounted to the corresponding vane.

At the same time, according to the embodiments of the present invention, the rotary shafts 150 all have the same axis of rotation 250. Thus, the first vane 210 and the second vane 220 are respectively rotatably fixed to the frame 100 with a common axis of rotation 250. Moreover, as shown in FIGS. 2A and 2B, the common axis of rotation 250 extends in the longitudinal direction L, and is located between the first side edge 121 and the second side edge 122, and in particular may be equidistant between the first side edge 121 and the second side edge 122, thereby approximately giving the active air intake assembly 1 a vertically symmetric appearance.

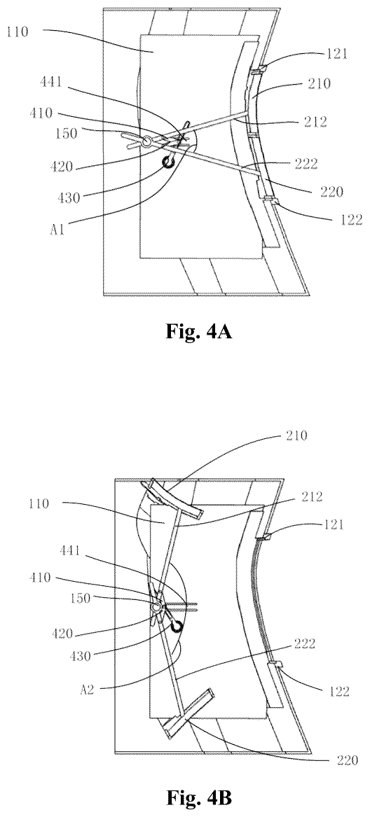

The drive apparatus 400 is mounted on one of the vertical plates 110 as shown in FIGS. 1B, 2A and 2B; see also FIGS. 4A and 4B. Specifically, the electric motor 460 is fixed to the vertical plate 110, and connected to the prime mover 430 of the drive apparatus 400 in a drivable manner. The common pivot 442, which is partially accommodated in the slide rail of the prime mover 430, is also partially accommodated in a limiting track 441 on the vertical plate 110, and the limiting track 441 extends linearly toward the opening 120 (i.e. horizontally in the figures). Thus, rotational motion of the prime mover 430 is converted into linear motion of the common pivot 442.

Furthermore, the first drive arm 410 is rotatably connected to one of the multiple first rotating arms 212 and a first rotating arm 212 adjacent thereto, and the second drive arm 420 is rotatably connected to one of the multiple second rotating arms 222 and a second rotating arm 222 adjacent thereto. Specifically, the first drive arm 410 is connected between a first end 2121 that is near the first vane 210 of this first rotating arm 212 and the rotary shaft 150, and the second drive arm 420 is connected between a first end 2221 that is near the second vane 220 of this second rotating arm 222 and the rotary shaft 150. Thus, the first rotating arm 212, the first drive arm 410, the second drive arm 420 and the second rotating arm 222 together form a mechanism of four connecting rods, and the first rotating arm 212 and the second rotating arm 222 form a scissor structure. Thus, the linear motion of the common pivot 442 is transformed into a change in the included angle between the first rotating arm 212 and the second rotating arm 222. As shown in FIGS. 4A and 4B, at the closed position, an included angle between the first rotating arm 212 and the second rotating arm 222 is a first included angle A1, and, at the open position, the included angle between the first rotating arm 212 and the second rotating arm 222 is a second included angle A2, and the second included angle A2 is greater than the first included angle A1. The first rotating arm 212 and the second rotating arm 222 respectively drive the movement of first vane 210 and the second vane 220. Thus, the drive apparatus 400 drives the movement of the first vane 210 and the second vane 220, such that the included angle varies between the first included angle A1 and the second included angle A2.

According to another embodiment of the present invention, a first rotating arm 212 may be arranged at both ends of each first vane section 215, and a second rotating arm 222 may be arranged at both ends of each second vane section 225. The first rotating arms 212 located at both ends of the first vane 210 and the second rotating arms 222 located at both ends of the second vane 220 are rotatably fixed to the frame 100. In addition, the drive apparatus 400 may also be arranged at end parts of the first vane 210 and the second vane 220, for example on a side plate at this end part on the frame 100. In addition, according to another embodiment of the present invention, the first vane 210 may comprise more than three or less than three first vane sections 215 arranged in the longitudinal direction L, and these first vane sections 215 are fixedly connected to each other. Correspondingly, the second vane 220 may comprise more than three or less than three second vane sections 225 arranged in the longitudinal direction L, and these second vane sections 225 are fixedly connected to each other

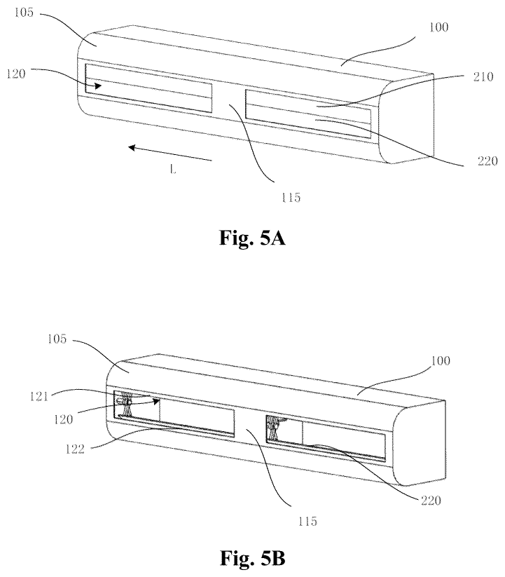

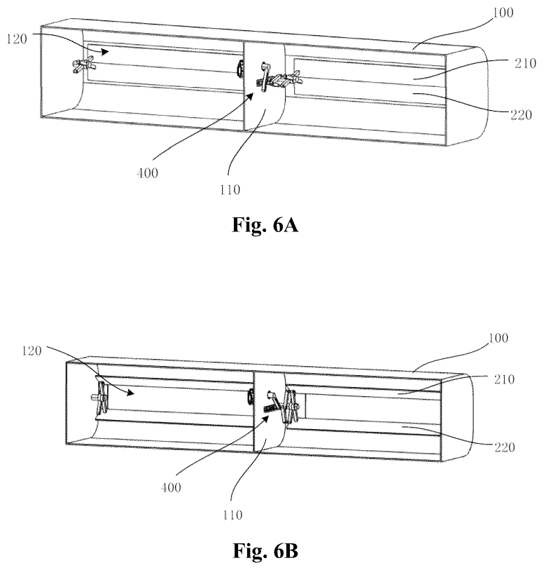

FIGS. 5A to 8B show the active air intake assembly 1 according to a second embodiment of the present invention. The active air intake assembly 1 of the second embodiment is identical or similar in many aspects to the active air intake assembly 1 of the first embodiment mentioned above, and the following only details the differences in the second embodiment.

First, the active air intake assembly 1 of the second embodiment also comprises a frame 100, a first vane 210 and a second vane 220. The frame 100 has an opening 120 extending in the longitudinal direction L for air intake. The opening 120 is defined by a first side edge 121 and a second side edge 122 that extend in the longitudinal direction L, and the frame 100 is further provided with a vertical beam 115 that extends from the first side edge 121 to the second side edge 122, thereby defining two opening sections. In the second embodiment, the frame 100, the first vane 210 and the second vane 220 all extend linearly.

The first vane 210 comprises two first vane sections 215 arranged in the longitudinal direction L, first rotating arms 212 are respectively fixedly mounted at two ends of each first vane section 215, and each first rotating arm 212 can also be rotatably mounted to a rotary shaft 150 of the frame 100, for example on the rotary shaft 150 on a side plate at a vane end part of a vertical plate 110 or the frame 100. The second vane 220 comprises two second vane sections 225 arranged in the longitudinal direction L, second rotating arms 222 are respectively fixedly mounted at two ends of each second vane section 225, and each second rotating arm 222 can also be rotatably mounted to the rotary shaft 150 of the frame 100. The rotary shafts 150 on the frame 100 are all collinear. Thus, the first vane 210 and the second vane 220 are respectively rotatably fixed to the frame 100 by a common axis of rotation 250, and are able to move away from each other from a closed position to an open position to open the opening 120.

In addition, a drive apparatus 400 and an electric motor 460 are both mounted on the vertical plate 110. Similar to the first embodiment, the electric motor 460 is configured to drive the prime mover 430 of the drive apparatus 400 to rotate, and a common pivot 442 is rotatably accommodated in a slide rail of the prime mover 430, so as to be able to slide along the prime mover 430. At the same time, a limiting track 441 on the vertical plate 110 for the common pivot 442 is configured as a linear sliding slot 441 that extends toward the opening 120 and runs through the vertical plate 110. Thus, the common pivot 442, on two sides of the vertical plate 110, respectively, drives a first drive arm 410 and a second drive arm 420 that form a pair.

That is, on either side of the vertical plate 110, one end of each of one first drive arm 410 and one second drive arm 420 are rotatably connected to the common pivot 442 to be driven thereby. Furthermore, in the second embodiment, the first rotating arm 212 has a first end 2121 and a second end 2122 that are located on two sides of the corresponding rotary shaft 150, and the first end 2121 is closer to the first vane 210 compared to the second end 2122, and the second rotating arm 222 has a first end 2221 and a second end 2222 that are located on two sides of the corresponding rotary shaft 150, and the first end 2221 is closer to the second vane 220 compared to the second end 2222. Thus, in the second embodiment, the other end of the first drive arm 410 is rotatably connected to the second end 2122 of the first rotating arm 212 that is remote from the first vane 210, and the other end of the second drive arm 420 is rotatably connected to the second end 2222 of the second rotating arm 222 that is remote from the second vane 220.

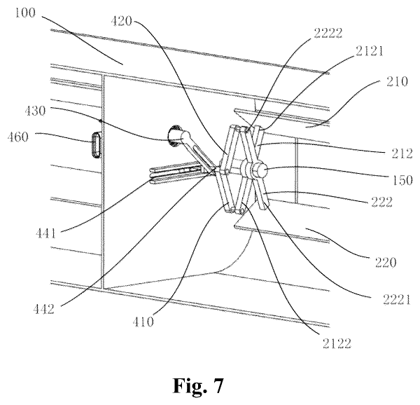

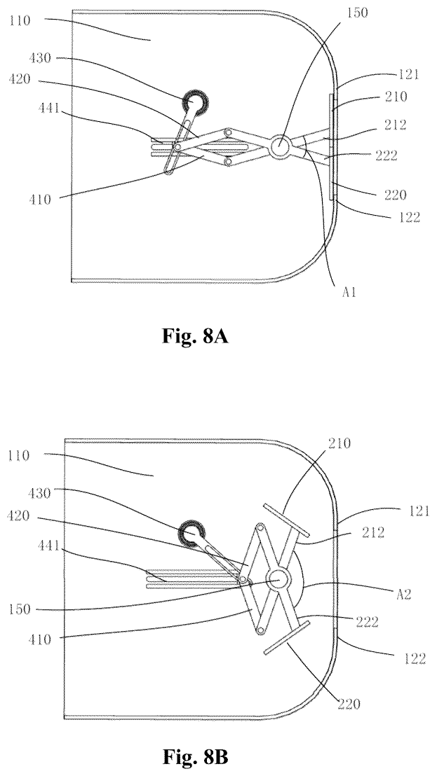

Therefore, as shown in FIGS. 7, 8A and 8B, the first rotating arm 212, the first drive arm 410, the second drive arm 420 and the second rotating arm 222, located on either side of the vertical plate 110, still form a mechanism of four connecting rods. The first rotating arm 212 and the second rotating arm 222 form a scissor structure, and an included angle between the first rotating arm 212 and the second rotating arm 222 can vary between a first included angle A1 and a second included angle A2, which causes the first vane 210 and the second vane 220 to vary between the closed position and open position.

While exemplary implementations of an active air intake assembly and motor vehicle proposed by the present invention have been described in detail above with reference to preferred embodiments, those skilled in the art can understand that various modifications and variations may be made to the specific embodiments without departing from the concept of the present invention, and that various combinations of the technical features and structures proposed by the present invention may be made without exceeding the scope of protection of the present invention.

1. An active air intake assembly, comprising:
a frame, wherein the frame extending in a longitudinal direction and having an opening for air intake; and
a first vane and a second vane that extend in the longitudinal direction, wherein the first vane and the second vane respectively being rotatably fixed to the frame by a common axis of rotation, and being able to move away from each other from a closed position to an open position to open the opening.

2. The active air intake assembly according to claim 1,
wherein the first vane is fixedly provided with a first rotating arm, one end of the first rotating arm is fixedly mounted to a main body of the first vane, and a part of the first rotating arm that is different from said end is rotatably mounted to a rotary shaft on the frame;
wherein the second vane is fixedly provided with a second rotating arm, one end of the second rotating arm is fixedly mounted to a main body of the second vane, and a part of the second rotating arm that is different from said end is rotatably mounted to the rotary shaft on the frame; and
wherein the first rotating arm and the second rotating arm form a scissor structure, such that, at the closed position, an included angle between the first rotating arm and the second rotating arm is a first included angle, and, at the open position, the included angle between the first rotating arm and the second rotating arm is a second included angle, and the second included angle is greater than the first included angle.

3. The active air intake assembly according to claim 1,
wherein the opening is defined by a first side edge and a second side edge that are opposite each other and extend in the longitudinal direction; and
wherein the common axis of rotation extends in the longitudinal direction, and the common axis of rotation is located between the first side edge and the second side edge.

4. The active air intake assembly according to claim 2, further comprising a drive apparatus, wherein the drive apparatus being configured to drive the first vane and the second vane, such that the included angle varies between the first included angle and the second included angle.

5. The active air intake assembly according to claim 4,
wherein the drive apparatus comprises a crank connecting rod mechanism, a first drive arm and a second drive arm,
wherein the crank connecting rod mechanism comprises a prime mover, and the first drive arm is rotatably connected to the first rotating arm,
wherein the second drive arm is rotatably connected to the second rotating arm, and the first drive arm and the second drive arm are rotatably connected to each other by means of a common pivot, and
wherein the common pivot is rotatably connected to the prime mover and slides relative to the prime mover.

6. The active air intake assembly according to claim 5,
wherein the first rotating arm has a first end and a second end that are located on two sides of the corresponding rotary shaft, and the first end of the first rotating arm is closer to the first vane compared to the second end of the first rotating arm, and
wherein the second rotating arm has a first end and a second end that are located on two sides of the corresponding rotary shaft, and the first end of the second rotating arm is closer to the second vane compared to the second end of the second rotating arm.

7. The active air intake assembly according to claim 6, wherein the first drive arm is rotatably connected to the second end of the first rotating arm, and the second drive arm is rotatably connected to the second end of the second rotating arm.

8. The active air intake assembly according to claim 5,
wherein the first vane comprises two or more first vane sections that are arranged in the longitudinal direction, and
wherein the second vane comprises two or more second vane sections that are arranged in the longitudinal direction.

9. The active air intake assembly according to claim 8,
wherein the first rotating arm is arranged at an end part of the first vane section, and
wherein the second rotating arm is arranged at an end part of the second vane section.

10. The active air intake assembly according to claim 8, wherein the drive apparatus is arranged in the longitudinal direction between the vane sections or at end parts of the vanes.

11. The active air intake assembly according to claim 1, wherein the first vane, the second vane and the opening all have a curved surface shape protruding at a middle part in the longitudinal direction away from an air intake channel, so that an olive-shaped opening can be formed between the first vane and the second vane.

12. A motor vehicle, comprising the active air intake assembly according to claim 1.
